(19) United States
(12) Patent Application Publication
(10) Pub. No.: US 2008/0013109 A1
(43) Pub. Date: Jan. 17, 2008

(54) Method for Selecting Printers Based On Paper Availability Or Paper Congestion

(76) Inventors: Yen-Fu Chen, Austin, TX (US); John Hans Handy-Bosma, Cedar Park, TX (US); Fabian F. Morgan, Austin, TX (US); Keith Raymond Walker, Austin, TX (US)

Correspondence Address: IBM CORP (YA);C/O YEE & ASSOCIATES PC, P.O. BOX 802333, DALLAS, TX, 75380, US

(21) Appl. No.: 11/456,608

(22) Filed: Jul. 11, 2006

(51) Int. Cl. G06F 3/12

(52) U.S. Cl. 358/1.1

(57) ABSTRACT

A printer or computer receives a user request to print. The printer measures a paper tray of the printer to form a measurement of an amount of paper in the paper tray. The printer transmits the measurement to a client computer in response to the user request to print.

### BACKGROUND OF THE INVENTION

1. Field of the Invention

The present invention relates generally to printer management. More specifically, the present invention relates to computer implemented methods to select printers based on paper availability or paper congestion and otherwise communicate with a printer.

2. Description of the Related Art

In organizations where many people require reliable and fast printing, network administrators centralize printing. A printer is a device that prints marks on paper in accordance with print instructions. Paper is material that accepts ink, or responds to heat in order to provide a contrasting pattern of one or more marks. Depending on the printing needs of an organization, the ratio of workers to a high-capacity laser printer may vary. However, the ratio generally ranges between two to twelve workers per printer. Rather than strictly assigning a printer to a worker, a worker may select several printers to form a pool of selected printers for daily use.

Microsoft Corporation offers one solution to permit pooling of printers through Microsoft® Windows® XP, which is an operating system commonly available on computers sold today. Microsoft and Windows are trademarks of Microsoft Corporation in the United States, other countries, or both. Such computers are also known as XP boxes. An XP box permits a user to select several printers but assign one as a default printer.

Unfortunately, XP boxes and other computer configurations report only limited information concerning a printer. XP boxes report statuses that often only refer to information concerning the storage of print instructions. Statuses include “spooling,” “printing,” and “deleting.” Very little information is reported concerning paper at the printer.

Attempts to collect information about paper have been made. Print management systems are known that monitor printer resources and send warning messages to system administrators, end users, and/or vendors when a printer resource falls below a predetermined threshold. Some printer resource system managers also can compare attributes for the updated printer resource levels with the attributes for the printer resource thresholds.

The known art addresses the problem of handling the office chore of filling common-use printers. Nevertheless, the known art does not permit ad hoc re-assessments of a printer measurement responsive to a user seeking to print. In contrast, the known art delivers information concerning a printer based on all changes to the local printer resources. However, most users do not care to know of all instances when a networked printer runs out of paper. Most users only care about available paper at a printer when a user is about to command a printer to print. Unfortunately, a user cannot automatically receive information concerning paper trays that would suggest to the user that a printer can accommodate a proposed print job. In addition, current computers do not report printers that are more suitable. In other words, current computers do not report that a second printer may have more paper available to print a particular print job.

### SUMMARY OF THE INVENTION

The methods described herein provide computer implemented methods for measuring an amount of paper at a printer. The printer or computer receives a user request to print. The printer measures a paper tray of the printer to form a measurement of an amount of paper in the paper tray. The printer transmits the measurement to a client computer in response to the user request to print.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a network in accordance with an illustrative embodiment;

FIG. 2 is a block diagram of a data processing system in accordance with an illustrative embodiment;

FIG. 3 is a block diagram of a printer in accordance with an illustrative embodiment;

FIG. 4 is a sequence of communications in accordance with an illustrative embodiment;

FIG. 5A is a dialog box on a client computer in accordance with an illustrative embodiment;

FIG. 5B is an alternative form of dialog box on a computer in accordance with an illustrative embodiment;

FIG. 6 is a flowchart of steps executed at a client computer or a printer server in accordance with an illustrative embodiment;

FIG. 7 is another flowchart of steps executed at a client computer or a printer server in accordance with an illustrative embodiment;

FIG. 8 is a flowchart of steps executed at a printer in accordance with an illustrative embodiment;

FIG. 9 is another flowchart of steps executed at a printer in accordance with an illustrative embodiment;

FIG. 10 is a flowchart of steps executed by a printer server or a computer in accordance with an illustrative embodiment; and

FIG. 11 is a dialog box on a client computer in accordance with an illustrative embodiment.

### DETAILED DESCRIPTION OF THE PREFERRED EMBODIMENT

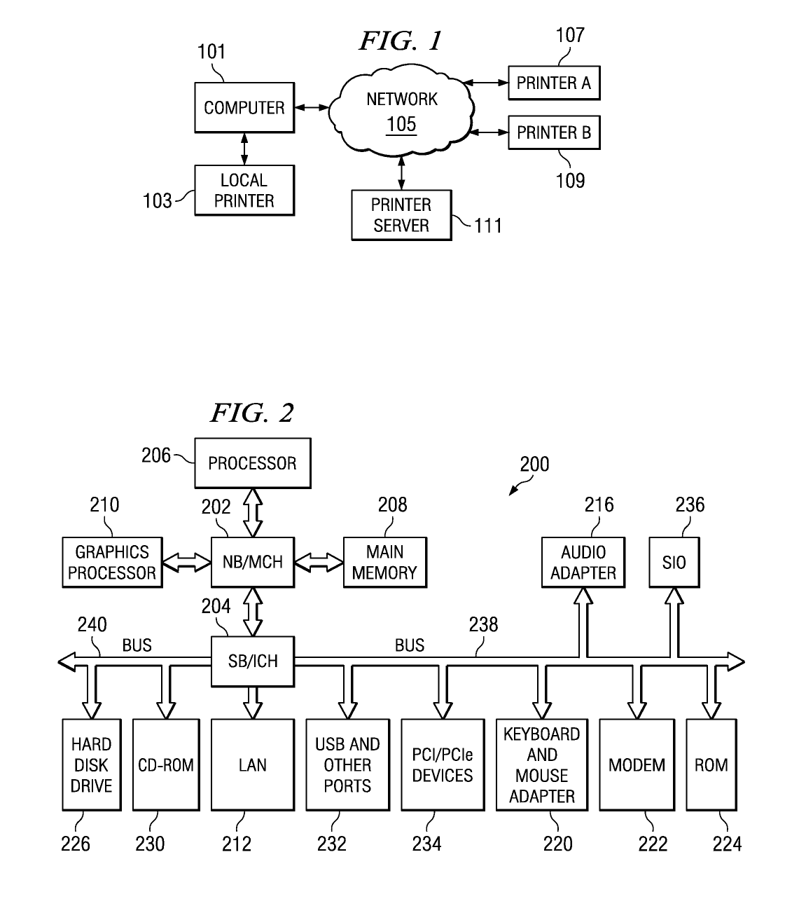

FIG. 1 is a block diagram of a network in accordance with an illustrative embodiment. A computer, such as computer 101, is a source for print requests. A print request is a set of print instructions transmitted by a computer or received at a printer, such as, local printer 103. A set of print instructions are one or more instructions for a printer to print text or graphics. A set of print instructions includes, for example, American Standard Code for Information Interchange (ASCII) characters, PostScript instructions, or any other print instruction convention instructions. Computer 101, if equipped with a monitor, is a client computer. A user is a person that operates a client computer. A user operating a client computer may trigger a print request when attempting to print a document. A client computer is a computer suited to receive user inputs and provide responsive outputs to a user or to a network.

As described above, a client computer receives triggers such as a user request to print. A user request to print is an input received at a client computer or server computer instructing the client computer or server computer to assess printer statuses and, optionally, offer printer options to the user. The client computer or server computer can be computer 101, for example. The input may be, for example, a sequence of keystrokes and mouse inputs. In addition, a user may enter such keystrokes and mouse movements in cooperation with a menu user interface. For example, a user may enter mouse movements by a clicking on a menu option to print. Computer 101 executes an application, for example, a word processor, art software, or other software.

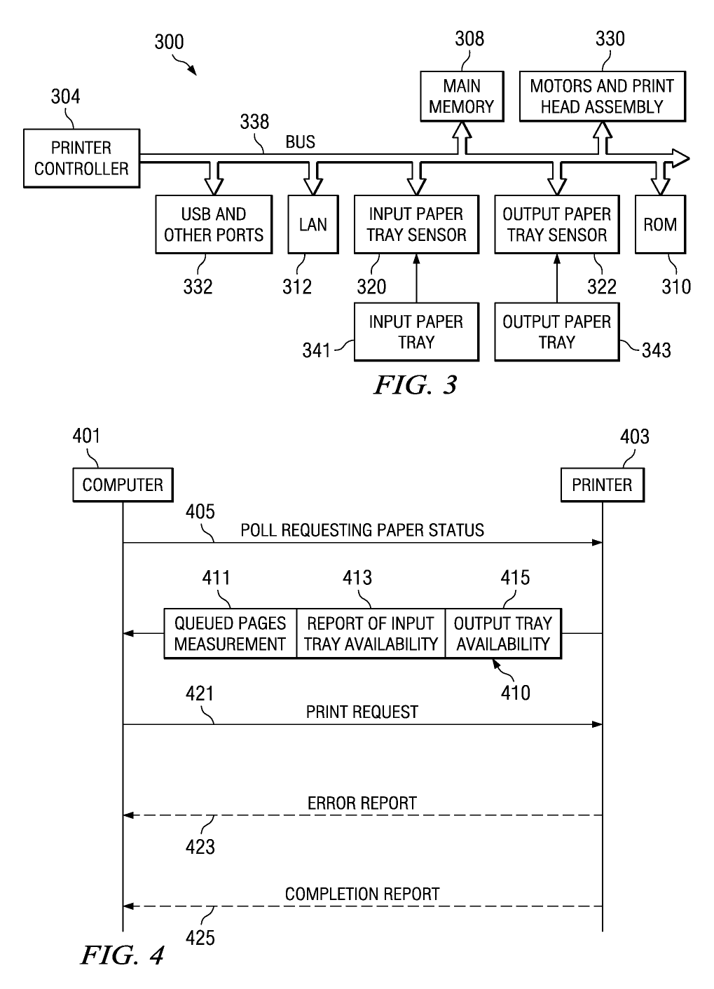

Computer 101 attaches to network 105. In addition, network 105 offers interconnect among printer A 107, printer B 109, and printer server 111. Printer A 107 has memory and a central processing unit to enhance its ability to connect to the network and to sort multiple print requests. Printer A 107 may have sufficient memory to handle complex print requests. Such memory may queue the print instructions in memory. Other features of printer A 107 will be discussed with reference to FIG. 3.

Similarly, printer server 111 may also provide memory to store some print instructions, as well as to better organize and sequence instructions from multiple computers. Printer servers are helpful in organizational environments where dozens of client computers contend for printer resources.

In support of receiving a user request to print, computer 101 permits the selection of a printer. Computer 101 may have two or more printers' connection details stored in memory. A user may add new printers to memory, if network 105 offers connection to the new printers.

The apparatus of FIG. 1 may support a network accessible printer capable of reporting to a client computer how much paper exists in an input paper tray. Furthermore, the apparatus supports the network accessible printer reporting whether a current user request to print can succeed based on reported paper availability. In addition, the apparatus supports the network accessible printer reporting a status of an output paper tray. The status of the output paper tray can be with respect to the output paper tray's capacity to accept more paper.

FIG. 2 is a block diagram of a data processing system in accordance with an illustrative embodiment. Data processing system 200 may be an exemplary embodiment of computer 101 of FIG. 1 in which code or instructions implementing the illustrative embodiment processes may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 connected to north bridge and memory controller hub 202. Graphics processor 210 connects to the MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 connects to south bridge and I/O controller hub 204.

An operating system runs on processor 206, and coordinates and provides control of various components within data processing system 200 in FIG. 2. The operating system may be a commercially available operating system such as Microsoft® Windows® XP. An object oriented programming system, such as the Java™ programming system, may run in conjunction with the operating system and provides calls to the operating system from Java programs or applications executing on data processing system 200. Java is a trademark of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the illustrative embodiments are performed by processor 206 using computer implemented instructions, which may be located in a memory such as, for example, main memory 208, read only memory 224, or in one or more peripheral devices.

Those of ordinary skill in the art will appreciate that the hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. In addition, the processes of the illustrative embodiments may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted example in FIG. 2 and above-described examples are not meant to imply architectural limitations. For example, data processing system 200 also may be a tablet computer, laptop computer, or telephone device in addition to taking the form of a PDA.

FIG. 3 is a block diagram of a printer in accordance with an illustrative embodiment. Printer 300 may be an exemplary embodiment of printer A 107 or printer B 109 of FIG. 1. Printer controller 304 controls printer functions. Read only memory 310 may host machine instructions governing the routine operation of printer 300. For example, power-on self-test code may be resident on read only memory (ROM) 310, which communicates with printer controller 304 via bus 338.

In addition, bus 338 permits communication of data and instructions among the remaining devices of printer 300, including main memory 308, local area network adapter (LAN) 312, input tray sensor 320, output tray sensor 322, motors and print head assembly 330, and USB and other ports 332. Main memory 308 stores program instructions and data, including queued print instructions. Local area network adapter 312 operates with a unique network address to permit transmitting and receiving of network traffic. Motors and print head assembly 330 operate to position paper and ink in order to produce a pattern according to the print instructions. USB and other ports 332 may operate as an alternative means for communicating to a computer. Such ports may be active in, for example, local printer 103 of FIG. 1.

Printer controller 304 may collect more information concerning printer operation than conventional printer controllers. For example, input paper tray sensor 320 measures paper in input paper tray 341. In addition, printer controller 304 may collect more information in the sense that printer controller 304 may have multiple input paper tray sensors. Multiple input paper tray sensors can measure paper in multiple input paper trays. A paper tray is a receptacle for storing paper stock, or collecting print output. The receptacle connects to a printer. Paper stock includes, for example, laminates, cardboard, vinyl, and other media used for printing. An output paper tray is a paper tray positioned to receive papers that a printer has printed.

Similarly, output paper tray sensor 322 measures paper in output paper tray 343 to form a measurement of an amount of paper in the output paper tray. Output paper trays are generally simple in construction. Output paper trays often are a bin with an open top.

As described, both output paper tray sensor 322 and input paper tray sensor 320 measure paper to form a measurement of an amount of paper in the input paper tray and output paper tray. A measurement is any dimension, weight, or density measurement of an amount of paper. A paper stack is a quantity of one or more papers, provided that if more than two papers exist, the papers overlap each other. A height of a paper stack is a dimension measured tangential to a broad surface of a page of paper in the stack.

FIG. 4 is a sequence of communications in accordance with an illustrative embodiment. Computer 401 is, for example, computer 101 of FIG. 1. Printer 403 is, for example, printer 300 of FIG. 3. Printer 403 may connect to a network, for example, network 105 of FIG. 1. The communications may culminate in either an error report or a completion report.

The communications begin with computer 401 sending a poll request to printer 403. A poll request is a message sent to a printer requesting a paper measurement or output tray availability. For example, a poll request may be “poll requesting paper status” 405. Output tray availability is an estimate or measurement of the ability for an output paper tray to collect paper in an orderly fashion. An output paper tray sensor may measure paper attributes. For example, attributes are weight of paper that accumulates on or in an output paper tray. A printer controller may convert this measurement to a number of pages that a printer can add before overflowing the tray. In contrast, paper congestion is a measurement of the extent to which paper fills an output paper tray.

Next, printer 403 responds with printer status report 410. A printer status report is a report from a printer transmitted to a computer. The printer status report includes a measurement. A measurement may include an estimate of an amount of paper. For example, printer status report 410 includes a report of input tray availability 413.

A printer status report can also include a report of input tray availability 413. Report of input tray availability 413 is a measurement of paper loaded in an input paper tray. Additionally, a printer status report can also include a report of output tray availability 415. Output tray availability 415 is a measurement of space for paper that an output paper tray can admit without substantial risk of paper overflow. A substantial risk of paper overflow can be a factory-measured average measurement for typical paper stock, the measurement corresponding to enough paper to cause an overflow. For example, the average may be determined by collecting data concerning a capacity of an output paper tray to accept sheets before paper starts to fall on the floor or otherwise falls outside of the output paper tray.

If available, printer status report 410 may also include queued pages measurement 411. A queued pages measurement is a calculated value of papers requested in print requests that are queued for printing, and header pages, if any. Queued pages measurement 411 may report zero or more queued pages. Additional information may accompany these estimates.

Provided printer status report 410 is favorable, computer 401 may transmit print request 421 to printer 403. A print request is a set of print instructions transmitted by a computer or received at a printer.

Next, printer 403 transmits error report 423. Alternatively, printer 403 transmits completion report 425. An error report describes an anomalous condition of the printer. In contrast, a completion report indicates a successful print has completed.

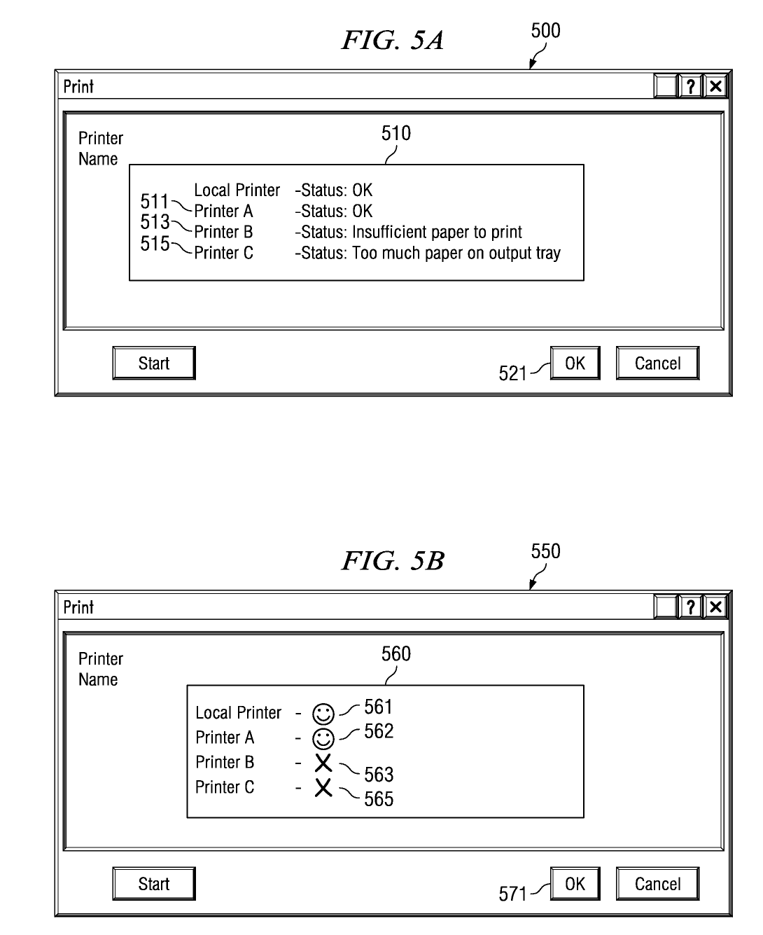

FIG. 5A is a dialog box on a computer in accordance with an illustrative embodiment. Dialog box 500 is a feature displayed on, for example, the display of computer 101 of FIG. 1. A computer can display dialog box 500 when the computer receives a printer status report. For example, a printer status report can be printer status report 410 of FIG. 4.

Dialog box 500 may include a selectable list of statuses 510. Computer 101 may display a status line for each printer that transmitted a printer status report. For example, printer A may report sufficient paper to print with “Status: OK” 511. In addition, printer B may report insufficient paper based on an input paper tray measurement measured by an input paper tray sensor. Consequently, computer 101 displays “Status: insufficient paper to print” 513. Furthermore, printer C may report too much paper on an output paper tray. In other words, the output tray availability is too low. Such a report corresponds to computer 101 displaying “Status: too much paper on output tray” 515.

The dialog box 500 can be responsive to user selections. A user may indicate acceptance of a selected printer by clicking on ‘OK’ button 521.

FIG. 5B is an alternative form of dialog box on a computer in accordance with an illustrative embodiment. An alternative form of dialog box 550 includes a list of statuses 560. However, alternative form of dialog box 560 is more concise than dialog box 500 of FIG. 5A in the sense that alternative form of dialog box 560 uses symbols instead of text to describe printer states. A computer can display alternative form of dialog box 560 when the computer receives a printer status report. For example, a printer status report can be printer status report 410 of FIG. 4.

Alongside each printer identity is a symbol that suggests the state of the printer. Smiling face 561 is alongside the legend ‘local printer’. Smiling face 561 indicates sufficient paper in the input paper tray and sufficient output tray availability. Smiling face 562 is alongside the legend ‘printer A’. Smiling face 562 indicates sufficient paper in the input paper tray and sufficient output tray availability. The symbolic smiling faces 561 and 562 may operate as a target. In response to the user hovering the user's mouse pointer over the target, the computer may expand the displayed status to give further details. For example, the computer may display the amount of paper measured at the printer.

Similarly, the computer may provide targets indicating a deficient condition. Unlike the smiling face symbol, X-mark 563 signals that a deficient condition exists at printer B. Similarly, X-mark 565 signals that a deficient condition exists at printer C. The computer also adds further information when the user hovers over these targets. For example, when the user hovers over the X-mark 565, the computer may respond by displaying “input paper tray needs attention,” nearby. Any other symbol or term or figure can be used instead of symbols smiling face 561, smiling face 562, X-mark 563, and X-mark 565.

When a user is satisfied with the currently selected printer, the user may click on ‘OK’ button 571. As a result of clicking or otherwise actuating ‘OK’ button 571, a print command is transmitted to the printer.

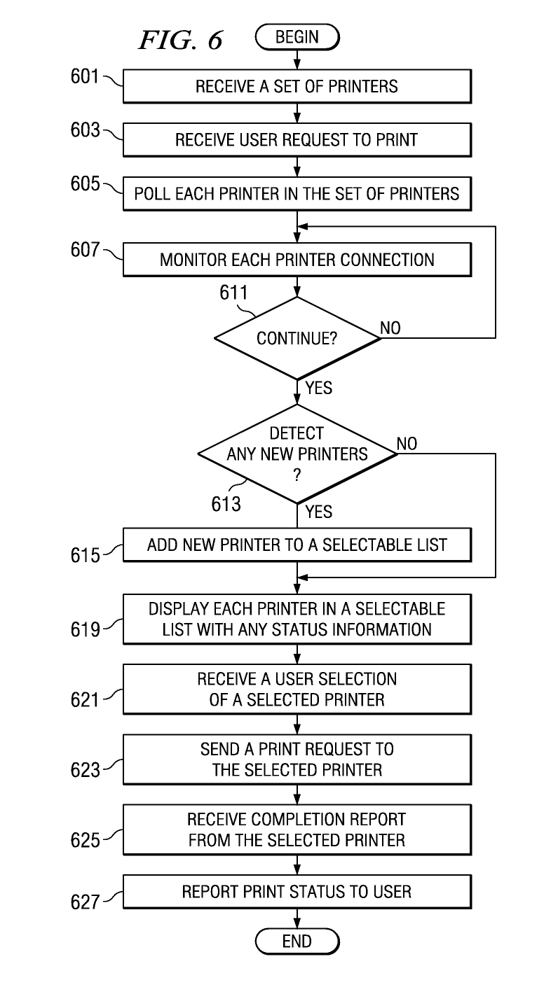

FIG. 6 is a flowchart of steps executed at a client computer or a printer server in accordance with an illustrative embodiment. A computer, for example, computer 101 of FIG. 1, executes the steps of the flowchart. The flowchart shows steps that a computer may take in order to provide a dialog box. For example, a dialog box may be dialog box 500 of FIG. 5. For example, a computer may be computer 401 of FIG. 4. The flowchart shows how a computer may facilitate feedback of printer statuses to a user. In addition, the flowchart shows how a computer facilitates user selection of a printer.

Initially, the computer receives from a user or a computer a set of printers (step 601). A set of printers is any collection of printers that may be selected for printing, regardless of a present ability of the collection to print. Thus, a set of printers includes those printers for which details are stored in computer 101's memory. The user may create a set of printers by using a program on the computer, for example, an add printer wizard. The add printer wizard collects a printer identification from the user through an interactive dialog.

Details of the list are stored to volatile or non-volatile storage, for example, hard disk drive 226 of FIG. 2. Storing a printer's network address may operate to add the printer to a set of printers. In the example of FIG. 1, local printer 103, printer A 107, and printer B 109 are stored, in some respect, in the memory of computer 101. The computer may execute step 601, for example, when rebooted. In this case, the computer can retrieve the set of printers from storage.

In addition to a user-selected set of printers, a network may be connected to a set of printers that a user has not selected. This set of printers is a second set of printers. A second set of printers is different from the first, user-selected set of printers. Nevertheless, a user may have the option, at various times, to add a printer from the second set of printers to the first set of printers. When a user adds a printer to the first set of printers, the printer ceases to be among the second set of printers.

Next, the computer receives a user request to print (step 603). For example, a user may select a print option from a menu with a mouse. The computer polls each printer in the set of printers (step 605). The computer polls each printer by either broadcasting a poll request on a network, or by addressing each printer by name or other unique identifier. In either case, the computer monitors each printer connection (step 607). The computer monitors the printer connections in order to receive a printer status report. Consequently, step 607 may include the computer receiving a printer status report. The printer status report may be, for example, printer status report 410 of FIG. 4. The computer may wait a period of time for all printers in the set of printers to respond. The computer may wait by determining whether to continue (step 611). For example, the computer may determine at step 611 whether a time-out has expired. As long as the time-out has not expired, the computer re-executes step 607. Once the time-out has expired, the computer processes further.

Next, a positive result to step 611 prompts the computer to detect if there are any new printers (step 613). A new printer may respond when the computer sends a broadcast message across a network. If the computer detects a new printer, the computer can add the new printer to a selectable list (step 615). The selectable list includes, for example, selectable list of statuses 510 of FIG. 5. The selectable list includes printers in the set of printers. Otherwise, if the computer does not detect a new printer, the computer displays each printer in the selectable list with any status information (step 619). Status information may include a legend that applies when no printer status report is available. The computer can execute step 619 following step 615. When the computer executes step 619, the computer may display dialog box 500 of FIG. 5A.

Optionally, the computer may await user input. The user now has detailed information available concerning the availability of printers. The computer receives a user selection of a selected printer (step 621). The user input may be a user selection of the printer from the at least one printer status report. Consequently, a user selection is a user input that selects a printer for an operation. The user selection may be a received click on an ‘OK’ button, for example, ‘OK’ button 512 of FIG. 5A. In this case, the computer may accept a default printer as the selected printer. Otherwise, a user may click on a name or other unique designator presented in the dialog box, followed with a click of the ‘OK’ button. The computer can also automatically select a printer based on pre-determined parameters such as paper level, printer location, or other parameters.

Having received the user input, the computer sends a print request to the selected printer (step 623). The computer may later receive a completion report from the selected printer (step 625). The completion report is, for example, completion report 425 of FIG. 4. The computer reports the print status to the user (step 627).

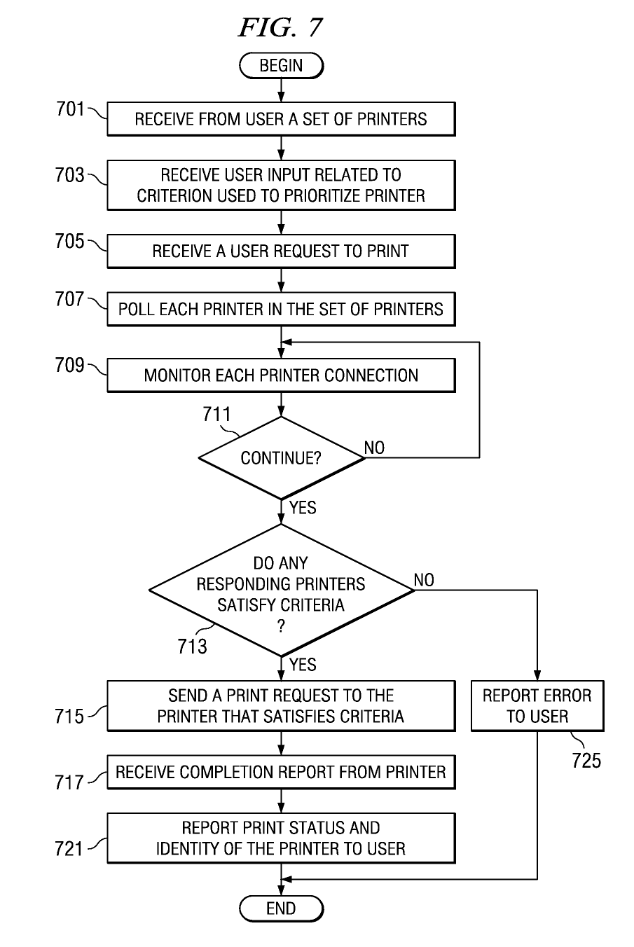

FIG. 7 is another flowchart of steps executed at a client computer or a printer server in accordance with an illustrative embodiment. A computer, for example, computer 101 of FIG. 1, executes the steps of the flowchart. The flowchart of FIG. 7 shows how a computer may automatically dispatch a print job once a user requests printing.

Initially, the computer receives from the user a set of printers (step 701). Like the steps of FIG. 6, the computer may receive the set of printers through an add printer wizard, through a process of looking up a set of printers at boot time, or from some other input. The process of looking up a set of printers may include, for example, looking up information concerning the approximate distance the printer may be from the user's physical location. In this case, a user may have measured and recorded such a distance as a walking distance between the user's physical location and the printer. Such a distance can be a factor that the user may consider when choosing a printer with which to print.

Next, the computer receives a user input related to a criterion with which to prioritize printers (step 703). The user can specify the criterion. The criterion can be based on an amount of paper. For example, a criterion can be a relational formula that compares a dimension, weight, or density with an amount of paper. When an amount of paper is known at each printer, and the size of the print job is known, the user may select a criterion, “where amount of paper in input paper tray exceeds print job paper requirement.” In addition, the computer may have recorded a number of queued pages for a printer.

Other criteria may be applicable. For example, Boolean operators may couple multiple criteria. As a further example, a user may also want to print, “where the printer is over 10 steps distant, but less than 50 steps distant.” The user may set a criterion to, “randomly selected printer.” A computer may invoke a randomizing algorithm to select a printer. Other criteria can be used.

Next, the computer receives a user request to print (step 705). The user request to print may be a received menu combination. The user may reach the menu combination by entering a keystroke combination. The menu, and any submenu, may offer mnemonic indicators to a user, for example, “file,” and “print.” Thus, a user may select the “file” from a menu, followed by selecting the entry marked “print” from a pop-up submenu.

Next, the computer polls each printer in the set of printers (step 707). The computer monitors each printer connection (step 709). Consequently, step 709 may include the computer receiving a printer status report. The computer may wait by determining whether to continue (step 711). For example, the computer may determine at step 711 whether a time-out has expired. The computer executes step 709 until the time-out expires.

Following time-out expiration, the computer determines whether any responding printer satisfies the criterion (step 713). The criterion is, for example, that a report of input tray availability is greater than the pages requested in the user request to print. A negative determination to step 713 prompts the computer to report an error to the user (step 725). The process terminates thereafter.

Additional embodiments may, rather than terminate following such an error, resume processing at step 701, or alternatively at step 703. In these cases, a user can recover from an error by adding printers to the set of printers or setting a more lenient criterion. Furthermore, as part of an error report, the computer can suggest an available printer suitable for the particular print job.

If a printer satisfies a criterion, the computer sends a print request to the printer that satisfies the criterion (step 715). Next, the computer receives a completion report from the printer (step 717). Finally, the computer reports the print status and identity of the printer to the user (step 721). The identity of the printer may be the name of a location. Processing terminates thereafter.

In the illustrative embodiment shown in FIG. 7, a computer automatically selects the printer based on a criterion. The selected printer is a printer that satisfies the criterion. For example, the selected printer may compare favorably to a second printer based on a metric from the selected printer being superior to a metric of the second printer. A metric may be a number established according to a formula that relates to an amount of paper. For example, the formula may be established by the user as a part of the criterion. Furthermore, the metric may be a number based on a relative distance between the printer and the user, printer speed, print quality, paper type, among other factors. The metric may be based on other parameters.

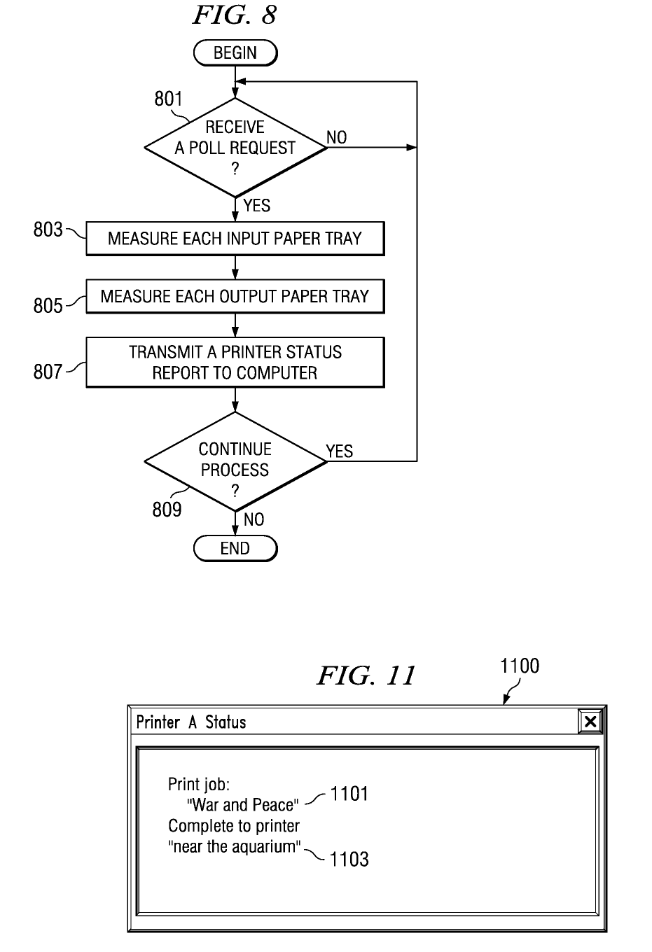

FIG. 8 is a flowchart of steps executed at a printer in accordance with an illustrative embodiment. A printer, for example, printer 300 of FIG. 3, executes the steps of the flowchart. The flowchart shows a relatively simple method for reporting a printer status report to a computer.

Initially, the printer checks to see if the printer has received a poll request (step 801). A computer may direct the poll request to the specific printer executing the steps of the flowchart. The poll request may be a broadcast poll request. If no poll request arrives, the printer re-executes step 801 until the printer receives a poll request.

Once the printer receives a poll request, the printer measures each input paper tray (step 803). Some printers may have two or more input paper trays. Consequently, step 803 may include adding a second input paper tray measurement of an amount to a first input paper tray measurement. The printer measures each output paper tray (step 805). The printer transmits a printer status report to the computer (step 807). The printer status report may include an amount of paper measured in step 803 as an input tray available measurement. Finally, the printer may determine whether to continue the process (step 809). A positive determination to step 809 leads to re-execution of the flowchart from step 801. A negative determination to step 809 causes the computer to terminate the process.

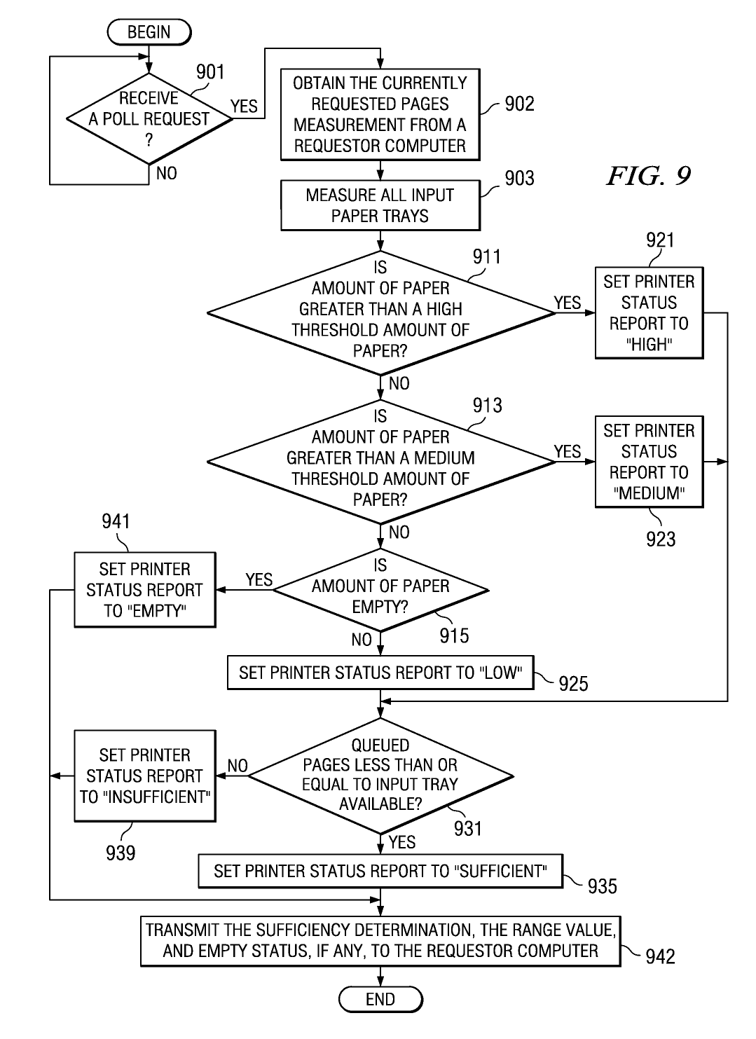

FIG. 9 is another flowchart of steps executed at a printer in accordance with an illustrative embodiment. A printer, for example, printer 300 of FIG. 3, executes the steps of the flowchart in order to set and send a printer status report. The printer status report may be, for example, printer status report 410 of FIG. 4.

The flowchart of FIG. 9 shows a method of generating an availability report that includes an assessment of whether the input paper trays are sufficient. A sufficiency determination is a determination that relates a demand for paper with a supply or amount of paper. A sufficiency determination results in a determination of sufficient when the amount of paper meets or exceeds the demand for paper. A sufficiency determination results in a determination of insufficient when the demand for paper exceeds the amount of paper. The determinations of “sufficient” or “insufficient” are both outcomes to a sufficiency determination.

Initially, the printer determines if the printer has received a poll request (step 901). The poll request is from a requester computer, for example, computer 101 of FIG. 1. Until a poll request arrives, the printer loops on step 901. Once a poll request arrives, the printer measures all input paper trays (step 903). The poll request may optionally include a currently requested pages measurement from a client computer. The printer obtains the currently requested pages measurement from the requester computer (step 902). The printer may parse the poll request to obtain this information.

The printer continues processing to assess if a measured amount of paper fits within a range value. A range value is a bounded range of amounts of paper. A range value may exclude zero or “empty.” A bounded range may be limited by a word formula, such as “high threshold amount.” In other words, a range value may be values of paper amounts that exceed the high threshold amount specified by the user.

Similarly, a range value may be values of paper amounts greater than a medium threshold amount specified by the user but less than or equal to a high threshold amount specified by the user. An amount of paper is a quantity of paper. An amount of paper may be a threshold amount of paper. For example, a high threshold amount of paper is a pre-selected amount selected by a user or a system administrator to indicate that, in the experience of the user, paper amounts exceeding the high threshold amount are sufficient for nearly all anticipated print jobs. A high threshold amount of paper may vary in accordance with the experiences of individuals and organizations.

Similarly, a medium threshold amount of paper is an amount selected by a user or a system administrator to indicate that paper amounts equal or exceeding the medium threshold but below the high threshold are suited for medium sized print jobs. A high threshold amount is greater than or equal to a medium threshold amount. A printer administrator may set a high threshold amount and a low threshold amount at the time the printer administrator installs a printer.

Returning to the FIG. 9 flowchart, the printer next begins assessing the measured amount of paper. The assessing may include distilling the total measurement of paper to form a range value. The steps of distilling may include steps 911, 913, 915, 921, 923, and 925. The printer determines whether the amount of paper is greater than a high threshold amount of paper (step 911). If the determination is true, then the printer sets the printer status report to “high” (step 921). Otherwise, the printer determines whether the amount of paper is greater than a medium threshold amount of paper (step 913). If the determination is true, then the printer sets the printer status report to “medium” (step 923). Otherwise, the printer determines whether the amount of paper is empty (step 915). If the determination is false, then the printer sets the printer status report to “low” (step 925). If the determination is true, the printer sets the status report to “empty” (step 941).

Following steps 921, 923, and 925, the printer determines whether the number of queued pages are less than or equal to the input tray availability (step 931). The printer may support step 931 by retrieving the queued pages measurement applicable to the printer. The queued pages may be an accumulated number of pages formerly requested by computers other than the requester computer. If the determination is positive, the printer sets the printer status report to “sufficient” (step 935). If the determination is negative, the printer sets the printer status report to “insufficient” (step 939). Following steps 935, 939, and 941 the printer transmits the sufficiency determination to a computer, such as a client computer (step 945). The process terminates thereafter.

In addition to an embodiment that measures input paper tray amounts in terms of “low,” “medium,” and “high,” an illustrative embodiment may summarize the state of the output paper tray in terms of a probability to overflow. Such output paper tray statuses can be “low probability of overflow,” “medium probability of overflow,” and “high probability of overflow.” Thus, an illustrative embodiment may report a status for the collective input trays as, for example, “low.” In addition, an illustrative embodiment may report a status for an output paper tray as “medium probability for overflow.”

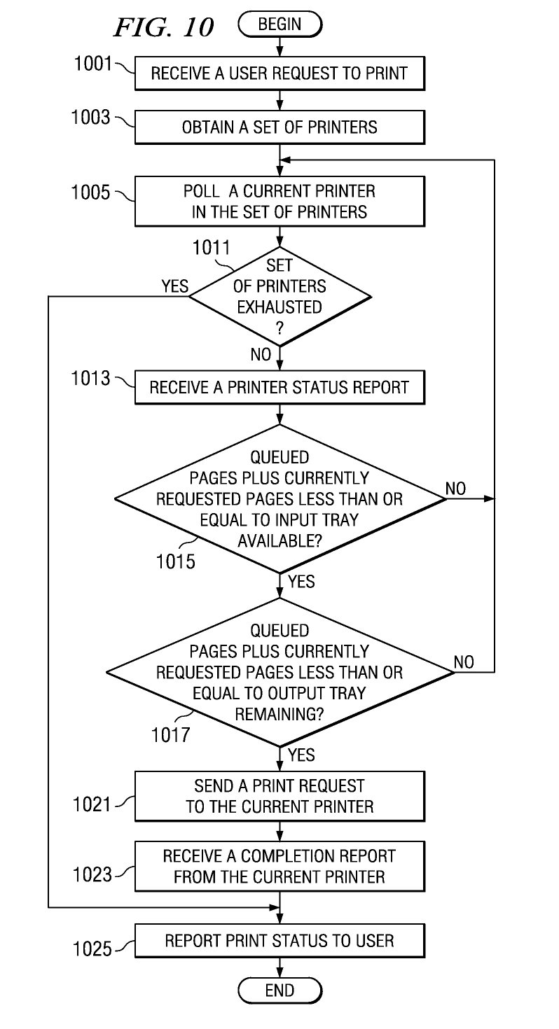

FIG. 10 is a flowchart of steps executed by a printer server or a computer in accordance with an illustrative embodiment. A computer, for example, computer 101 of FIG. 1, executes the steps of the flowchart. The flowchart illustrates steps for a computer to select printers automatically based on having sufficient capacity to handle a new print job.

Initially, the computer receives a user request to print (step 1001). The computer obtains a set of printers (step 1003) which could potentially execute the request to print. The computer polls a current printer in the set of printers (step 1005). The computer determines whether the set of printers is exhausted (step 1011). Step 1011 provides an exit condition to a loop if the determination to step 1011 is positive. A set of printers is exhausted, for example, when all printers in the set have transmitted printer status reports. At steps 1005 and 1011, the computer selects a printer to be the “current printer” or handles each printer as a “current printer” until an exit condition is met. Exit conditions will be described further in relation to step 1017. A currently requested pages measurement is at least a measurement of pages that a current print job defines. The currently requested pages measurement may be incremented by one to accommodate printing a header page with a print out of the current print job.

In the event step 1011 yields a negative result, the computer receives a printer status report (step 1013). The printer status report includes, for example, a queued pages measurement, a measurement of the output paper tray remaining, and a report of input tray availability. The printer status report may include a total measurement of paper in at least two paper trays. The total measurement is all paper measurements of a set of paper trays at a printer. The total measurement includes, for example, the sum of paper measurements for all input paper trays.

Next, the computer compares information in the printer status report with criteria described in steps 1015 and 1017. First, the computer determines whether the queued pages measurement plus currently requested pages measurement are less than or equal to the input paper tray availability (step 1015). Unless the determination is true, the computer resumes polling a next printer at step 1005.

Second, the computer determines whether the queued pages measurement plus the currently requested pages measurement are less than or equal to the output paper tray remaining (step 1017). Unless the determination is true, the computer resumes polling a next printer at step 1005.

However, if the determination at step 1017 is true, the computer sends a print request to the current printer (step 1021). The true determination is an example of an exit condition. The computer receives a completion report from the current printer (step 1023). Finally, the computer reports the print status to user (step 1025). In addition, an exit condition may be a positive determination at step 1011. A positive determination at step 1011 prompts the computer to execute step 1025.

FIG. 11 is a dialog box on a client computer in accordance with an illustrative embodiment. The computer displays status dialog box 1100, for example, when reporting the print status to user at step 1025 of FIG. 10. Status dialog box 1100 may include a descriptive name of the print job, “War and Peace” 1101. In addition, status dialog box 1100 may include a descriptive name of the location corresponding to an automatically selected printer, “near the aquarium” 1103.

The illustrative embodiments have a number of advantages over existing printer paper tracking technologies. For example, a user is provided information concerning input paper availability as well as concerning capacity remaining in an output paper tray. An illustrative embodiment provides automatic selection of a printer based on the printer having sufficient capacity to handle a new print job. In addition, an illustrative embodiment reports paper statuses to a requesting computer.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for measuring an amount of paper at a printer, the computer implemented method comprising:
receiving a user request to print;
measuring a paper tray of the printer to form a measurement of an amount of paper in the paper tray in response to receiving the user request; and
transmitting the measurement to a client computer in response to the user request to print.

2. The computer implemented method of claim 1, further comprising:
responsive to receiving the user request, determining whether the amount of paper is sufficient.

3. The computer implemented method of claim 2, wherein the amount of paper is measured according to a height of a paper stack in an output paper tray.

4. The computer implemented method of claim 1, wherein the step of receiving comprises:
receiving a poll request; and
responsive to receiving the poll request, determining whether the amount of paper is sufficient.

5. The computer implemented method of claim 4, wherein the user request to print comprises a set of print instructions.

6. The computer implemented method of claim 5, wherein the step of transmitting comprises:
transmitting a sufficiency determination of insufficient.

7. A computer implemented method for selecting a printer, the computer implemented method comprising:
receiving a criterion, the criterion based on an amount of paper;
polling a set of printers;
receiving at least one printer status report from the set of printers in response to polling the set of printers, wherein the at least one printer status report includes a measurement of the amount of paper in an output paper tray of at least one printer in the set of printers; and
responsive to receiving the at least one printer status report, selecting a printer from among the set of printers, wherein the at least one printer status report satisfies the criterion.

8. The computer implemented method of claim 7, wherein the step of selecting further comprises:
receiving a selected printer from a user.

9. The computer implemented method of claim 7, further comprising:
displaying statuses of the set of printers based on the at least one printer status report.

10. The computer implemented method of claim 9, wherein selecting further comprises:
receiving a user selection of the printer, wherein the printer is selected from a group of printers specified in the at least one printer status report.

11. The computer implemented method of claim 10, wherein receiving further comprises:
receiving a second printer status report from a printer in a second set of printers, wherein receiving the user selection is further based on receiving the second printer status report.

12. The computer implemented method of claim 7 wherein the criterion is specified by a user.

13. The computer implemented method of claim 7 wherein the criterion comprises a first criterion and wherein the computer implemented method further comprises:
receiving second a criterion, the second criterion based on an amount of paper, wherein the at least one printer status report satisfies the second criterion.

14. A computer implemented method for generating status reports, the computer implemented method comprising:
receiving a poll request in response to polling a printer;
measuring a first input paper tray of the printer to form a first measurement of an amount of paper in the first input paper tray;
measuring a second input paper tray of the printer to form a second measurement of an amount of paper in the second input paper tray;
adding the second measurement to the first measurement to form a total measurement of paper in at least two paper input trays; and
responsive to receiving the poll request, transmitting the total measurement to a computer, the total measurement comprising a printer status report.

15. The computer implemented method of claim 14, further comprising:
comparing a queued pages measurement and a currently requested pages measurement with the total measurement to form a sufficiency determination; and
transmitting the sufficiency determination to the computer.

16. The computer implemented method of claim 15, wherein comparing further comprises:
retrieving the queued pages measurement; and
obtaining the currently requested pages measurement from a client computer.

17. The computer implemented method of claim 16, wherein adding further comprises:
incrementing at least one page to the currently requested pages measurement.

18. The computer implemented method of claim 14, further comprising:
distilling the total measurement to form a range value prior.

19. The computer implemented method of claim 18, wherein the total measurement is a range value that excludes zero.

20. The computer implemented method of claim 19, wherein comparing further comprises:
retrieving a queued pages measurement; and
obtaining a currently requested pages measurement from a client computer.
